(19) United States
(12) Patent Application Publication
(10) Pub. No.: US 2020/0208568 A1
(43) Pub. Date: Jul. 2, 2020

(54) COMPRESSOR FOR A CHARGING DEVICE OF AN INTERNAL COMBUSTION ENGINE, THROTTLE MODULE, AND CHARGING DEVICE FOR AN INTERNAL COMBUSTION ENGINE

(71) Applicant: Vitesco Technologies GMBH, Hannover (DE)

(72) Inventors: Mathias Bogner, Straubing (DE); Christoph Schäfer, Coburg (DE); Sasa Slavic, Heidelberg (DE)

(73) Assignee: Vitesco Technologies GMBH, Hannover (DE)

(21) Appl. No.: 16/815,544

(22) Filed: Mar. 11, 2020

Related U.S. Application Data
(63) Continuation of application No. PCT/EP2018/070119, filed on Jul. 25, 2018.

(30) Foreign Application Priority Data
Sep. 14, 2017 (DE) 10 2017 216 324.0

(51) Int. Cl. F02B 37/12

(52) U.S. Cl. CPC F02B 37/12

(57) ABSTRACT

A compressor for an internal combustion engine supercharging device is disclosed, having a compressor housing in which a compressor wheel is arranged on a rotor shaft; and an air-feed channel for conducting an air flow to the compressor wheel. The compressor has a throttle module, having an iris diaphragm mechanism arranged upstream of the compressor wheel, multiple lamellae and which closes or opens a diaphragm aperture by the lamellae, allowing variable adjustment of a cross-section for the air flow to the compressor wheel. A throttle module housing at least partially delimits the air-feed channel and in and/or on which the iris diaphragm mechanism is mounted. An actuator is mounted on the throttle module housing and mechanically coupled to the iris diaphragm mechanism for actuation thereof. The throttle module is formed as a structural unit separate from the compressor housing and flange-mounted on the compressor housing by the throttle module housing.

### CROSS REFERENCE TO RELATED APPLICATION

This application claims the benefit of PCT Application PCT/EP2018/070119, filed Jul. 25, 2018, which claims priority to German Application DE 10 2017 216 324.0, filed Sep. 14, 2017. The disclosures of the above applications are incorporated herein by reference.

### FIELD OF INVENTION

The invention relates to a compressor for a supercharging device of an internal combustion engine, to a throttle module for a compressor of a supercharging device, and to a supercharging device for an internal combustion engine.

### BACKGROUND

Supercharging devices such as exhaust-gas turbochargers are increasingly being used to increase power in motor vehicle internal combustion engines. More and more frequently, this is done with the aim of reducing the overall size and weight of the internal combustion engine for the same power or even increased power and, at the same time, of reducing consumption and thus CO₂ emissions, with regard to ever stricter legal requirements in this respect. The principle of action consists in using the energy contained in the exhaust-gas flow to increase a pressure in an intake tract of the internal combustion engine and thus to bring about better charging of a combustion chamber of the internal combustion engine with atmospheric oxygen. In this way, more fuel, such as gasoline or diesel, can be converted in each combustion process, that is to say the power of the internal combustion engine can be increased.

An exhaust-gas turbocharger has an exhaust-gas turbine arranged in the exhaust tract of the internal combustion engine, a fresh-air compressor arranged in the intake tract and a rotor bearing arranged therebetween. The exhaust-gas turbine has a turbine housing and, arranged therein, a turbine impeller which is driven by the exhaust-gas mass flow. The fresh-air compressor has a compressor housing and a compressor impeller arranged therein, which builds up a boost pressure. The turbine impeller and the compressor impeller are arranged rotationally conjointly on the opposite ends of a common shaft, referred to as the rotor shaft, and thus form what is referred to as the turbocharger rotor. The rotor shaft extends axially between the turbine impeller and compressor impeller through the rotor bearing arranged between the exhaust-gas turbine and fresh-air compressor, and is rotatably mounted in the rotor bearing in the radial and axial directions in relation to the rotor shaft axis. In this construction, the turbine impeller driven by the exhaust-gas mass flow drives the compressor impeller via the rotor shaft, thereby increasing the pressure in the intake tract of the internal combustion engine downstream of the fresh-air compressor in relation to the air mass flow, and thereby ensuring better charging of the combustion chamber with atmospheric oxygen.

In terms of its operating behavior, the compressor is characterized by a so-called compressor characteristic map, which describes the pressure build-up versus the mass throughput for different compressor rotational speeds or circumferential speeds. A stable and usable characteristic map of the compressor is bounded toward low throughputs by the so-called surge limit, toward relatively high throughputs by the so-called choke limit, and in terms of structural mechanics by the maximum rotational speed limit. In adapting a supercharging device such as an exhaust-gas turbocharger to an internal combustion engine, a compressor is selected which has a compressor characteristic map which is as expedient as possible for the internal combustion engine. The following preconditions should be satisfied here:

a. an engine full-load curve should lie completely within the usable compressor characteristic map;
b. minimum clearances with respect to the characteristic map limits, as required by the vehicle manufacturer, should be maintained;
c. maximum compressor efficiencies should be available at the rated load and in a range of a low-end apex torque of the internal combustion engine; and
d. the compressor wheel should have a minimum moment of inertia.

Simultaneous satisfaction of all the preconditions mentioned would be possible only to a limited extent with a conventional compressor without additional measures. For example, the following conflicting aims would arise from opposing trends:

a. reduction in the moment of inertia of the compressor and maximization of the characteristic map width and of the peak efficiency,
b. reduction of scavenging in the region of the low-end apex torque and maximization of the specific rated power,
c. improvement of the response behavior and increase in the specific rated power of the internal combustion engine.

The stated conflicting aims could be resolved by a compressor design which has a wide characteristic map with a minimum moment of inertia and maximum efficiencies on the full-load curve of the engine.

Apart from the steady-state requirements mentioned, stable operating behavior of the compressor must be ensured in transient operating states as well, for example in the case of a rapid load dump of the internal combustion engine. That is to say, the compressor must not enter the state of so-called surging even in the event of a sudden decrease of the conveyed compressor mass flow.

While being restricted to the compressor inlet of an exhaust-gas turbocharger, the abovementioned solution has hitherto been achieved by additional measures, such as an adjustable inlet guide vane assembly, measures for reducing an inlet cross section of the radial compressor or a fixed recirculation channel, also referred to as a ported shroud or characteristic-map-stabilizing measure. In the case of the variable solutions, the widening of the useful working range of the compressor is achieved through active shifting of the characteristic map. In this regard, during engine operation at low rotational speeds and throughputs, the compressor characteristic map is shifted to the left toward low mass flows, whereas during engine operation at high rotational speeds and throughputs, the compressor characteristic map is not shifted or is shifted to the right.

Through the setting of vane angles and the induction of a pre-swirl in or counter to the direction of rotation of the compressor wheel, shifting of the entire compressor characteristic map toward relatively low or relatively high throughputs is realized by the inlet guide vane assembly. However, the adjusting mechanism of the inlet guide vane assembly constitutes a delicate, complicated and expensive solution.

The measures involving constriction of the compressor inlet by cross-section reduction shift the compressor characteristic map toward relatively low throughputs by virtue of the inlet cross section being reduced by closing the structure immediately upstream of the compressor. In the open state, these measures open up the entire inlet cross section again as far as possible and hence do not or only marginally influence or shift the characteristic map. Possible solutions of this kind are described in US 2016/265424 A1 or DE 10 2011 121 996 A1.

The fixed recirculation channel is a passive solution. It extends the useful characteristic map range of the compressor without fundamentally shifting the characteristic map thereof. It constitutes a significantly more expedient but at the same time less efficient solution in relation to the inlet guide vane assembly and the described variable cross-section reduction.

For the purpose of avoid surging in the case of a rapid load dump, use is commonly made of a so-called overrun air recirculation valve which, in the event of a sudden decrease in the charge air mass flow through the engine, opens a bypass from the compressor outlet to the compressor inlet and thus keeps the compressor in the stable characteristic map range to the right of the surge limit. A combination of active measures, such as the variable inlet guide vane assembly and the overrun air recirculation valve, is conceivable but unusual.

### SUMMARY

Example embodiments are generally directed to a supercharging device which contributes to efficient operation.

A compressor, for example a radial compressor, for a supercharging device of an internal combustion engine is disclosed. The compressor has a compressor housing in which a compressor wheel is arranged rotationally conjointly on a rotatably mounted rotor shaft. The compressor has an air feed channel for conducting an air mass flow to the compressor wheel. The compressor has a throttle module which has an iris diaphragm mechanism arranged upstream of the compressor wheel. The iris diaphragm mechanism has multiple lamellae and is designed to close or open a diaphragm aperture by means of the lamellae, thus allowing variable adjustment of a flow cross section for the air mass flow for admission to the compressor wheel. The throttle module furthermore has a throttle module housing which at least partially delimits the air feed channel and in and/or on which the iris diaphragm mechanism is arranged and mounted. The throttle module has an actuator which is mounted on the throttle module housing and which is mechanically coupled to the iris diaphragm mechanism for the actuation thereof. The throttle module is formed as a structural unit which is separate from the compressor housing and which is flange-mounted on the compressor housing by means of the throttle module housing.

Correspondingly to the compressor, a throttle module is disclosed which has the above-stated features and functions.

The compressor for the supercharging device provides a modular, variable iris diaphragm mechanism which is typically arranged directly upstream of the compressor inlet for the purposes of shifting the characteristic map. The iris diaphragm mechanism may also be referred to as iris diaphragm or iris throttle and has the task of setting the inlet mass flow of the compressor by way of stepless variation of the flow cross section. In this case, the iris throttle acts like a kind of mask for an outer region of the compressor inlet. With increasing throttling, that is to say cross-sectional narrowing, the iris throttle in effect performs the function of an overrun air recirculation valve, since it can prevent surging of the compressor. This makes it possible to actively influence the operating range of the compressor and, in addition, to keep the compressor at a stable operating point in the event of a sudden load dump of the engine.

The iris diaphragm mechanism has multiple lamellae which are displaceable relative to one another by rotation. The iris diaphragm mechanism is mounted in or on the above-stated (fixed) throttle module housing. Each lamella is mounted at one side in or on the throttle module housing and at the other side on a movably mounted adjusting ring. The lamellae are synchronized and moved jointly by means of the adjusting ring. Rotation of the adjusting ring also triggers rotation of the lamellae. When the lamellae are rotated parallel to the axis of rotation of the compressor wheel, the lamellae pivot radially inward and thus cause a desired narrowing of the flow cross section directly upstream of the compressor wheel. The adjusting ring itself is actuated and moved by means of the actuator. The actuator is an electrically or pneumatically operated adjuster.

A lamella has a substantially plate-like and/or planar lamella main body, which serves for the screening of the air mass flow and thus for the setting of the diaphragm aperture. For the mounting on the throttle module housing and adjusting ring, a lamella has for example two holding elements (also actuation elements), which, for example, are each arranged in a fastening portion of the lamella main body. A holding element is for example in the form of a holding pin or pin-like holding body. A holding element typically extends normal to a main plane of extent of the lamella main body. The fastening portions may be formed for example as a first and a second end or as a first and second end region of the respective lamella. The two fastening portions of a lamella typically have identical wall thicknesses.

The air feed channel is formed in the compressor. For example, the air feed channel is formed by the throttle module housing and optionally at least partially by the compressor housing.

The described compressor or the throttle module provide a modular design for the compressor with a variable inlet geometry. This means that the iris diaphragm mechanism, the actuator and the throttle module housing together form a closed unit, specifically the throttle module, which is flange-mounted directly on the compressor, that is to say in modular fashion. The connection to the compressor housing is realized for example by means of a screw connection, a clamping connection (for example a V-band-type clamp) or other non-destructively releasable connecting technologies.

The modular design yields at least the following advantages:

a. Heat conduction from the compressor housing into a housing of the iris diaphragm mechanism, for example the throttle module housing, is at least reduced, whereby a thermal load on all of the components of the throttle module decreases. Measures may additionally be implemented which further reduce heat conduction between the throttle module and the compressor itself. For example, a corresponding design of the connection of the throttle module housing to the compressor housing is provided through the provision of, for example, heat shields, insulation materials or isolation materials or the like.
b. The modular construction permits easier exchangeability of the throttle module (also referred to as variable compressor inlet unit) in the event of possible damage. Conversely, it is however also possible, in the event of damage to the compressor or supercharging device, for the throttle module to possibly be retained if it is not damaged. The compressor and thus the supercharging device are altogether easier to maintain and cheaper for the end customer to repair in the event of damage.
c. The throttle module likewise permits easier retrofittability in the aftermarket sector. This possibility is advantageous because, after a certain mileage of the vehicle, an end customer may compensate for the performance deficits that occur, at least in the low-end torque range and with regard to a time-to-torque.
d. Furthermore, the modular design enables the vehicle manufacturer to selectively equip engines with or without a throttle module. The variant without throttle module and thus variable settability of the flow cross section constitutes an inexpensive engine design, whereas the option with a throttle module makes it possible to realize a version with increased power or optimized consumption by means of the Miller concept. Since the other components are typically substantially identical, considerable use may be made of synergistic effects in the assembly of the different engine variants, resulting in lower costs and a saving of energy and resources and thus reduced CO2 emissions from the engine production process.
e. The production of compressors or supercharging devices with a variable compressor inlet is much simpler with the throttle module of modular design in relation to a variant of the iris diaphragm mechanism integrated into the compressor housing. The entire mechanism may be procured as a purchased part. Only the flange-mounting and fastening of the throttle module is performed on the production line. Furthermore, production with and without a throttle module is possible on the same line.

The throttle module housing itself may be of single-part or multi-part form.

In one embodiment, a seal is formed in a flange region between the throttle module housing and the compressor housing. Through the provision of the seal, the flow chamber of the air mass flow is sealed off to the outside in the flange region.

In one embodiment, a damper element is arranged in the flange region between the throttle module housing and the compressor housing. In a further embodiment, the damper element simultaneously functions as a seal, or the damper element is alternatively provided in addition to the seal. By means of the damper element, which is designed for example as a rubber buffer or rubber seal, a low-vibration connection of the throttle module to the compressor housing is realized. The result is a considerable reduction in the vibration load on all components of the throttle module. For example, a large-area rubber seal is provided.

In one embodiment, the throttle module housing and/or the compressor housing has, in the flange region, a groove for receiving a seal and/or a damper element. This permits reliable and simple installation of a seal and/or a damper element.

In one embodiment, the actuator is mechanically coupled via an opening in the throttle module housing to the iris diaphragm mechanism for the actuation thereof, wherein the actuator is arranged on the throttle module housing such that the opening is closed off in sealed fashion by means of the actuator.

In the case of the described compressor, the actuator itself functions as part of a seal. In other words, a seal integrated into the actuator is provided. In this way, the flow chamber, for example the air feed channel and the chamber within the throttle module housing in which the iris diaphragm mechanism is mounted, is sealed off with respect to surroundings of the compressor. In this way, no leakage flows from within the compressor to the outside surroundings may occur. The actuator and the throttle module housing as counterpart are consequently sealingly connected to one another. The throttle module housing encloses at least one adjusting ring and the lamellae of the iris diaphragm mechanism.

By means of the described sealing concept, it is advantageously the case that improved durability is attained, because there is no need for sealing against moving parts. The actuator seals against the throttle module housing, such that the seal is realized between two parts which do not move during operation. The sealing concept contributes to lower outlay in terms of assembly and production. Furthermore, a contribution is made to an inexpensive solution and to a particularly wear-free solution. A further advantage is that the elements of the iris diaphragm mechanism, in particular the lamellae and the adjusting ring, may move freely within the throttle module housing. Adjusting forces for the setting of the diaphragm aperture are thus significantly lower in relation to an embodiment in which the moving parts would be sealed, because in this case additional friction would be generated owing to the contact between sealing surfaces and sliding surfaces.

A further advantage includes the lubrication of the encapsulated iris diaphragm mechanism with a lubricant, for example grease. The encapsulation prevents the lubricant from washing out. The lubrication is therefore substantially maintenance-free. A further advantage includes the coupling between the actuator and the iris diaphragm mechanism may be designed to be particularly short owing to the direct connection of the actuator to the throttle module housing. This contributes to a reduction of a structural space requirement. A further advantage is that an additional cover for sealing off the iris diaphragm mechanism may be omitted. This contributes to a situation in which the compressor and thus the supercharging device as a whole may be produced in a more compact and inexpensive form.

In one embodiment, the actuator is designed as a cover for the opening of the throttle module housing. This contributes to the above-stated advantages and functions. In particular, there is no need for an additional cover to be provided, because this function is integrated into the actuator itself.

In a further embodiment, the actuator has a flat underside, by means of which the actuator is fixed from the outside to the throttle module housing so as to cover the opening. Particularly simple assembly and reliable functioning are thereby ensured.

In one embodiment, a seal is provided which surrounds the opening and which is arranged between the actuator and the throttle module housing. The seal is for example an O-ring or some other sealing element. The seal has for example a rubber material. This effects the sealing function described above.

In one embodiment, the actuator or the throttle module housing has a groove which surrounds the opening and in which the seal is arranged. In this way, the seal is securely fixed to one of the two components or received therein.

In one embodiment, the actuator is mechanically coupled by means of a coupling mechanism to an adjustable adjusting ring of the iris diaphragm mechanism for the purposes of closing or opening the diaphragm aperture. The coupling mechanism is substantially a mechanism which couples the actuator to the adjusting ring, such that the latter may be actuated. The coupling mechanism includes, for example, a coupling rod which is connected rotationally conjointly to an actuator shaft of the actuator and which is connected fixedly to the adjusting ring for the purposes of adjusting the latter. For example, the coupling rod is connected fixedly to the adjusting ring via a coupling pin.

In one embodiment, the actuator is fixed by means of a holder to the throttle module housing, and the coupling mechanism is at least partially exposed to the outside. Such a variant constitutes an outwardly open coupling mechanism. In the case of such a design, easy installation of the actuator on the holder and of the coupling thereof to the iris diaphragm mechanism is realized.

In one embodiment, the coupling mechanism is arranged within the throttle module housing, which is closed off in sealed fashion to the outside by the actuator. In other words, the actuator is coupled to the iris diaphragm mechanism, for the actuation thereof, via the coupling mechanism arranged within the throttle module housing.

In this way, the coupling mechanism is likewise entirely integrated into the throttle module housing and jointly sealed off by the actuator. The coupling mechanism is thus not exposed, whereby contamination thereof may be prevented or largely prevented. This contributes overall to a long service life of the iris diaphragm mechanism, wherein undisturbed functionality is ensured over a long period of time. Additionally, analogously to the above, efficient and effective lubrication of the integrated coupling mechanism with lubricants such as grease is made possible. The encapsulation prevents the lubricant from washing out, and maintenance-free lubrication is provided.

Also disclosed is a supercharging device for an internal combustion engine, which supercharging device has a rotor bearing in which a rotor shaft is rotatably mounted, and has a compressor according to one of the previously described embodiments. The supercharging device is designed as an exhaust-gas turbocharger or as an electromotively operated supercharger or as a supercharger operated via a mechanical coupling to the internal combustion engine. Thus, for example, the supercharging device is designed as an exhaust-gas turbocharger which has an exhaust-gas turbine for driving the compressor impeller of the compressor or, alternatively, is designed as an electromotively operated supercharger (also referred to as an E-booster), which has an electromotive drive for driving the compressor impeller of the compressor. As an alternative to the abovementioned embodiments, the supercharging device may furthermore also be designed as a supercharger operated via a mechanical coupling to the internal combustion engine. Such a coupling between the internal combustion engine and the radial compressor may be realized by means of an intermediate transmission, for example, which is operatively connected to a rotating shaft of the internal combustion engine, on the one hand, and to the rotor shaft of the radial compressor, on the other hand.

The supercharging device substantially allows the above-stated advantages and functions. In particular, the above-described compressor is suitable in all embodiments both for an exhaust-gas turbocharger, in which, as mentioned at the beginning, a turbine is driven by an exhaust-gas mass flow, and for an electromotively operated supercharger. An electromotively operated supercharger or a supercharging device having an electromotively operated supercharger is also referred to as a so-called E booster or E compressor.

### BRIEF DESCRIPTION OF THE DRAWINGS

Example embodiments of the invention will be described below with the aid of the appended figures. Identical elements or elements of identical action are provided with the same reference designations throughout the figures.

In the figures:

FIG. 1 shows a schematic sectional view of a supercharging device with a compressor with an iris diaphragm mechanism,

FIGS. 2A to 2C show schematic plan views of the iris diaphragm mechanism in three different states, and

FIGS. 3 to 5 show schematic cross-sectional views of compressors with throttle module according to example embodiments of the invention.

### DETAILED DESCRIPTION

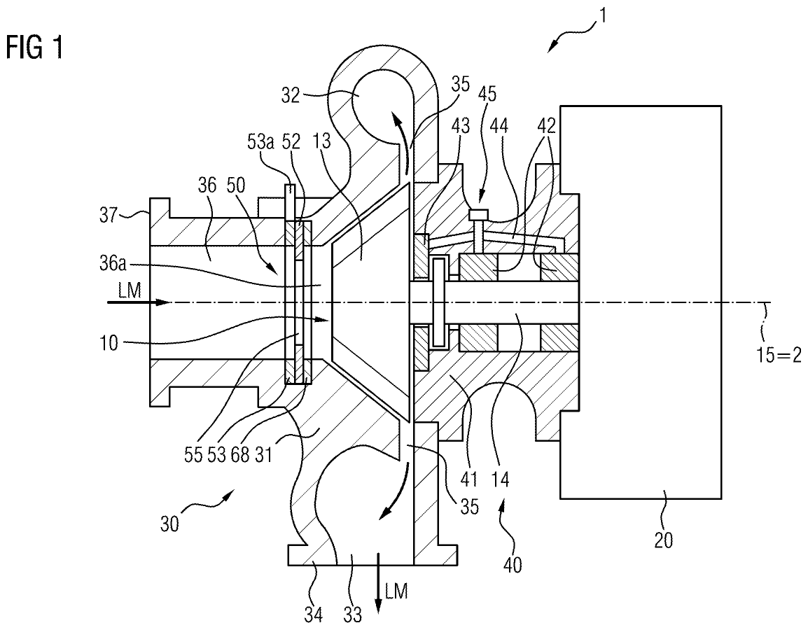

FIG. 1 schematically shows, in a sectional illustration, an example of a supercharging device 1, which includes a compressor 30 (a radial compressor in this case), a rotor bearing 40 and a drive unit 20. The compressor 30 has an optional overrun air recirculation valve (not illustrated), and an air mass flow LM is also indicated by arrows. A so-called supercharger rotor 10 of the supercharging device 1 has a compressor impeller 13 (also referred to as compressor wheel) and a rotor shaft 14 (also referred to as shaft). The supercharger rotor 10 rotates about a rotor axis of rotation 15 of the rotor shaft 14 during operation. The rotor axis of rotation 15 and at the same time the supercharger axis 2 (also referred to as longitudinal axis) are illustrated by the indicated center line and identify the axial orientation of the supercharging device 1. The supercharger rotor 10 is mounted with its rotor shaft 14 in a bearing housing 41 by means of two radial bearings 42 and an axial bearing disk 43. Both the radial bearings 42 and the axial bearing disk 43 are supplied with lubricant via oil supply channels 44 of an oil connection 45.

In this example, a supercharging device 1, as illustrated in FIG. 1, has a multi-part construction. Here, a housing of the drive unit 20, a compressor housing 31 which is able to be arranged in the intake tract of the internal combustion engine, and a rotor bearing 40 which is provided between the housing of the drive unit 20 and the compressor housing 31 are arranged adjacent to one another with respect to the common supercharger axis 2 and are connected together in terms of assembly, wherein alternative arrangements and configurations of drive units and rotor bearings are also possible.

The supercharger rotor 10 constitutes a further structural unit of the supercharging device 1 and has at least the rotor shaft 14 and the compressor impeller 13, which compressor impeller is arranged in the compressor housing 31 and has an impeller blade arrangement 131. The compressor impeller 13 is arranged at one end of the rotor shaft 14 and is connected rotationally conjointly to the latter. The rotor shaft 14 extends in the direction of the supercharger axis 2 axially through the bearing housing 41 and is mounted in the axial and radial directions therein so as to be rotatable about its longitudinal axis, the rotor axis of rotation 15, wherein the rotor axis of rotation 15 lies on the supercharger axis 2, that is to say coincides therewith.

The compressor housing 31 has an air feed channel 36, which optionally has an intake pipe connector piece 37 for connection to the air intake system (not illustrated) of the internal combustion engine and runs in the direction of the supercharger axis 2 toward the axial end of the compressor impeller 13. Via this air feed channel 36, the air mass flow LM is drawn in from the air intake system by the compressor impeller 13 and conducted to the compressor wheel 13. The air feed channel 36 may also be part of an intake connector and thus not part of the compressor housing 31. The air feed channel 36 adjoins for example the compressor housing 31 and forms a compressor inlet 36a for conducting the air mass flow LM to the compressor impeller 13.

Furthermore, the compressor housing 31 generally has a ring-shaped channel which is arranged in ring-shaped fashion around the supercharger axis 2 and the compressor impeller 13 and which widens in spiral fashion away from the compressor impeller 13, and which is referred to as a spiral channel 32. Said spiral channel 32 has a gap opening which runs at least over a part of the inner circumference and which has a defined gap width, the so-called diffuser 35, which, directed in a radial direction away from the outer circumference of the compressor impeller 13, runs into the spiral channel 32, and through which the air mass flow LM flows away from the compressor impeller 13 at elevated pressure into the spiral channel 32.

The spiral channel 32 furthermore has a tangentially outwardly directed air discharge channel 33 with an optional manifold connector piece 34 for connection to an air manifold (not illustrated) of an internal combustion engine. Through the air discharge channel 33, the air mass flow LM is conducted at elevated pressure into the air manifold of the internal combustion engine.

The drive unit 20 is not shown in any more detail in FIG. 1 and may be embodied either as an exhaust-gas turbine or as an electromotive drive unit or as a mechanical coupling to the internal combustion engine, for example as an intermediate transmission, which is operatively connected to a rotating shaft of the internal combustion engine, making the supercharging device 1 into an exhaust-gas turbocharger in one case and into an electromotively operated supercharger, also referred to as an E booster or E compressor, or into a mechanical supercharger, in the other case. In the case of an exhaust-gas turbocharger, a turbine impeller (also referred to as turbine wheel) would for example be provided opposite the compressor wheel 13, which turbine impeller would likewise be arranged rotationally conjointly on the rotor shaft 14 and driven by an exhaust-gas mass flow.

Upstream of the compressor impeller 13 in the air mass flow LM, an iris diaphragm mechanism 50, in addition to or as an alternative to an overrun air recirculation valve (see FIG. 1), is arranged in the air feed channel 36 directly upstream of a compressor inlet 36a (also compressor entry) and/or forms at least one sub-region of the air feed channel 36 directly upstream of the compressor inlet 36a of the compressor housing 31. With regard to its functional principle, the iris diaphragm mechanism 50 is similar to an iris diaphragm in a camera. The iris diaphragm mechanism 50 is designed to at least partially close or open a diaphragm aperture such that a flow cross section for the air mass flow LM for admission into the compressor impeller 13 may be set variably at least over a partial region of the flow cross section. The iris diaphragm mechanism 50 allows a characteristic map shift for the compressor 30 in that it functions as a variable inlet throttle for the compressor wheel 13.

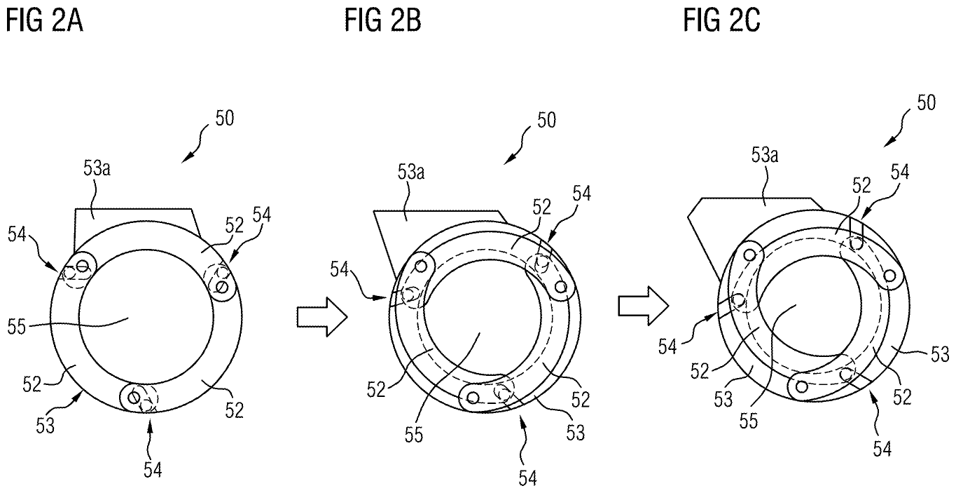

FIGS. 2A to 2C schematically show the iris diaphragm mechanism 50 of the supercharging device 1 in three different operating states. The iris diaphragm mechanism 50 is fixed on or in the compressor housing 31 and/or at least partially forms the latter. Alternatively, the iris diaphragm mechanism 50 is mounted on a separate, fixed housing for the iris diaphragm mechanism 50. Alternatively, the iris diaphragm mechanism 50 is mounted on or in a multi-part housing, wherein a part of the multi-part housing is formed by the compressor housing 31 and a part is formed by an additional, separate housing (element). The iris diaphragm mechanism 50 has a bearing ring 68 which is fixed in the air feed channel 36 so as to be concentric with the compressor inlet 36a, an adjusting ring 53 which is arranged so as to be concentric with the bearing ring and is rotatable about a common center and has an adjusting lever 53a, and a plurality of lamellae 52 which are mounted so as to be rotatable about a respective center of rotation in the bearing ring 68. Instead of the bearing ring 68, the compressor housing 31 or another housing (element) may also serve as a bearing. The lamellae 52 have for example a plate-like lamella main body and at least one pin-like actuating element (not visible here), which is designed for actuating the respective lamella 52, as integral or separate constituent parts of the respective lamella 52.

The lamellae 52 are also rotatable and/or displaceable on the adjusting ring 53, for example by means of the actuating element. In the example, the adjusting ring 53 has three grooves 54 (indicated in the figures) for the mounting/guiding of the lamellae 52. The lamellae 52 are synchronized and moved by means of the adjusting ring 53. The adjusting ring 53 is mounted for example on or in the housing. By actuation of the adjusting ring 53, the lamellae 52 are pivoted radially inward and narrow a diaphragm aperture 55 of the iris diaphragm mechanism 50. Here, FIG. 2A shows the diaphragm aperture 55 with a maximum opening width (open position), FIG. 2B shows the diaphragm aperture 55 with a reduced opening width, and FIG. 2C shows the diaphragm aperture 55 with a minimum opening width (closed position).

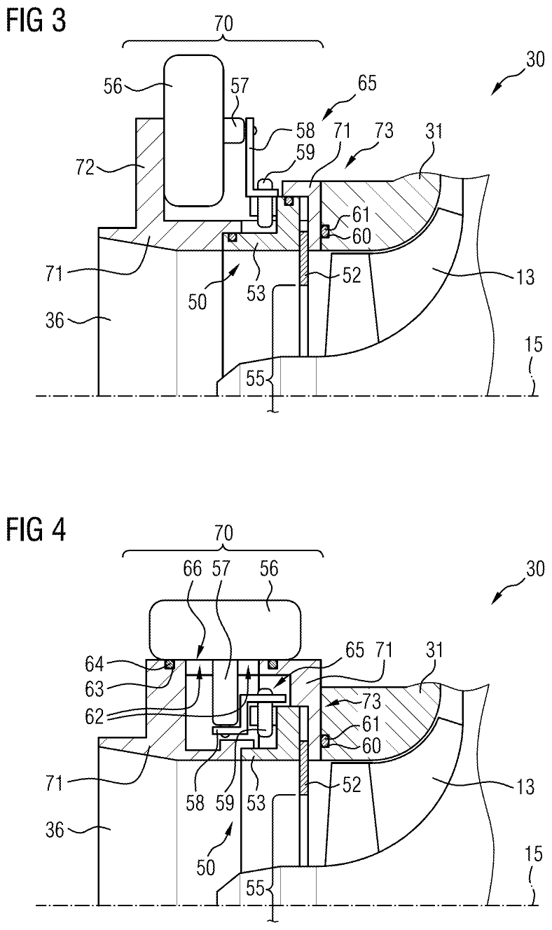

FIG. 3 shows, in a schematic side view, a compressor 30 according to an example embodiment of the invention, which replaces the compressor described on the basis of FIG. 1. The compressor 30 substantially corresponds to the compressor described on the basis of FIG. 1, with a separate throttle module 70 being provided.

The throttle module 70 is a modular structural unit which is formed separately from the compressor housing 31 of the compressor 30. The throttle module 70 includes a throttle module housing 71, in or on which an iris diaphragm mechanism 50, a coupling mechanism 65 and an actuator 56 are mounted or fixed. On the throttle module housing 71, there is formed a holder 72, to which the actuator 56 is fixed. The actuator 56 is mechanically coupled to the iris diaphragm mechanism 50 by means of the coupling mechanism 65 in order to actuate the iris diaphragm mechanism. The iris diaphragm mechanism 50 corresponds to the mechanism described above, wherein no bearing ring is provided in the example embodiment of FIG. 3. The iris diaphragm mechanism 50 is illustrated with the adjusting ring 53 and lamellae 52, which delimit the diaphragm aperture 55. The coupling mechanism 65 has a coupling rod 58 and a coupling pin 59. The coupling rod 58 is connected rotationally conjointly to an actuator shaft 57 of the actuator 56. The coupling rod 58 in turn is fixedly connected by way of a coupling pin 59 to the adjusting ring 53, for example the above-mentioned adjusting lever, for the actuation thereof. Rotation of the actuator shaft 57 causes the adjusting ring 53, and thus, as mentioned in the introduction, the lamellae 52, to be adjusted. The coupling mechanism 65 may also include further elements provided for coupling the actuator 56 to the adjusting ring 53, or may be of entirely different construction.

As mentioned, the throttle module 70 is designed or configured as a separate structural unit, which is flange-mounted onto the compressor housing 31. In particular, the throttle module housing 71 is fixedly connected to the compressor housing 31. The connection to the compressor housing 31 is implemented, for example, in the form of a screw connection.

In a flange region 73 between the compressor housing 31 and the throttle module housing 71, an optional groove 60 is formed in the compressor housing 31, which groove extends around the rotor axis of rotation 15 and in which groove a seal 61 is received, such that the throttle module 70 is sealingly connected to the compressor housing 31. In this way, the flow chamber in the compressor 30 is sealed off. The seal 61 may simultaneously function as a damper element. For example, the seal 61 is a rubber seal.

In the example embodiment shown in FIG. 3, the coupling mechanism 65 and also at least part of the iris diaphragm mechanism 50 are exposed to the outside. This permits simple assembly of the throttle module and of the components thereof.

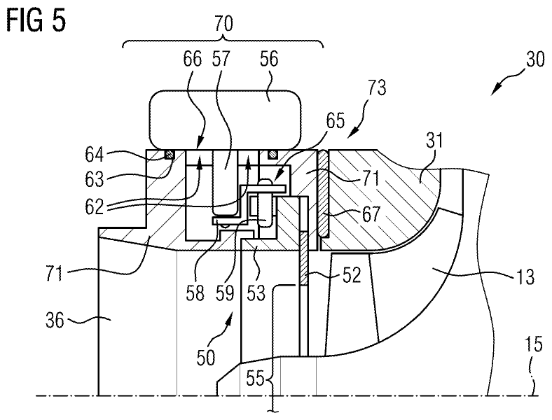

FIG. 4 shows, in a schematic side view, a compressor 30 having a throttle module 70 according to a further example embodiment. The compressor 30 has, substantially analogously to the above, identical or functionally identical components, wherein the throttle module 70 is of slightly different construction. By contrast to the previous example embodiment, the iris diaphragm mechanism 50 and the coupling mechanism 65 are arranged within the throttle module housing 71. In other words, the actuator shaft 57, the coupling rod 58, the coupling pin 59 and the iris diaphragm mechanism 50 are entirely integrated into the throttle module housing 71. The throttle module 70 is, analogously to the above, mechanically connected to the compressor housing 31.

In the example embodiment shown in FIG. 4, the actuator 56 functions as a cover for the throttle module housing 71 and sealingly closes an opening 62 of the throttle module housing 71. For this purpose, the actuator 56 has a flat underside 66, by means of which it completely covers the opening 62. Additionally, the throttle module housing 71 has, surrounding the opening 62, a further groove 63 in which a further seal 64 is arranged. Alternatively, the further groove 63 and the further seal 64 are arranged in the actuator 56 itself.

FIG. 5 substantially corresponds to the example embodiment as per FIG. 4, wherein the throttle module 70 is connected by means of a damper element 67, which is formed as a seal with damping action, to the compressor housing 31 in the flange region 73. The damper element 67 is a seal which provides damping over a large area.

It should be pointed out at this juncture that the described compressor 30 does not necessarily have to be part of the supercharging device 1 described by way of example in FIG. 1. Rather, the supercharging device 1 may also be configured differently.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

1. A compressor for a supercharging device of an internal combustion engine, comprising:
a compressor housing, in which a compressor wheel is arranged rotationally conjointly on a rotatably mounted rotor shaft;
an air feed channel for conducting an air mass flow onto the compressor wheel; and
a throttle module, which has
an iris diaphragm mechanism which is arranged upstream of the compressor wheel, which has multiple lamellae and which is configured to close or open a diaphragm aperture by the lamellae, thus allowing variable adjustment of a flow cross section for the air mass flow for admission to the compressor wheel;
a throttle module housing which at least partially delimits the air feed channel and in and/or on which the iris diaphragm mechanism is arranged and mounted; and
an actuator which is mounted on the throttle module housing and which is mechanically coupled to the iris diaphragm mechanism for the actuation thereof;
wherein the throttle module is formed as a structural unit which is separate from the compressor housing and which is flange-mounted on the compressor housing by the throttle module housing.

2. The compressor as claimed in the preceding claim 1, wherein the throttle module housing is fixed to the compressor housing by at least one screw connection and/or one clamping connection.

3. The compressor as claimed in claim 1, wherein a seal is formed in a flange region between the throttle module housing and the compressor housing.

4. The compressor as claimed in claim 1, wherein a damper element is arranged in a flange region between the throttle module housing and the compressor housing.

5. The compressor as claimed in claim 1, wherein the throttle module housing and/or the compressor housing has, in a flange region between the throttle module housing and the compressor housing, a groove for receiving a seal and/or a damper element.

6. The compressor as claimed in claim 1, wherein the actuator is mechanically coupled via an opening in the throttle module housing to the iris diaphragm mechanism for actuation thereof, wherein the actuator is arranged on the throttle module housing such that the opening is closed off in sealed fashion by the actuator.

7. The compressor as claimed in claim 1, wherein the actuator is mechanically coupled by a coupling mechanism to an adjustable adjusting ring of the iris diaphragm mechanism for closing or opening the diaphragm aperture.

8. The compressor as claimed in claim 7, wherein the actuator is fixed a holder to the throttle module housing, and the coupling mechanism is at least partially exposed to outside.

9. The compressor as claimed in claim 7, wherein the coupling mechanism is arranged within the throttle module housing, which is closed off in sealed fashion to outside by the actuator.

10. A throttle module for a compressor of a supercharging device of an internal combustion engine, comprising:
an iris diaphragm mechanism which is arranged upstream of a compressor wheel, which has multiple lamellae and which is configured to close or open a diaphragm aperture, thus allowing variable adjustment of a flow cross section for the air mass flow for admission to the compressor wheel;
a throttle module housing which at least partially delimits an air feed channel and in which the iris diaphragm mechanism is arranged and mounted; and
an actuator which is mounted on the throttle module housing and which is mechanically coupled to the iris diaphragm mechanism for actuation thereof;
wherein the throttle module is formed as a structural unit which is separate from a compressor housing of the compressor such that the throttle module is flange-mounted on the compressor housing.

11. A supercharging device for an internal combustion engine, having a rotor bearing in which a rotor shaft is rotatably mounted, comprising a compressor as claimed in claim 1, wherein the supercharging device is configured as an exhaust-gas turbocharger, as an electromotively operated supercharger, or as a supercharger operated via a mechanical coupling to the internal combustion engine.
